(19) United States
(12) Patent Application Publication
(10) Pub. No.: US 2025/0350963 A1
(43) Pub. Date: Nov. 13, 2025

(54) DEPENDENCY-AWARE PROVISIONING, ORCHESTRATION, AND SERVICE EXECUTION

(71) Applicant: T-Mobile USA, Inc., Bellevue, WA (US)

(72) Inventors: Raymond E. Reeves, Orlando, FL (US); Simon Youngs, Overland Park, KS (US)

(21) Appl. No.: 18/660,034

(22) Filed: May 9, 2024

(51) Int. Cl. H04W 24/02; H04L 41/08; H04L 41/0813

(52) U.S. Cl. CPC H04W 24/02; H04L 41/0813; H04L 41/0886

(57) ABSTRACT

A system coupled to a telecommunications network is disclosed. The system receives a request to implement a configuration change on a network access node from an Operation Support System (OSS). The system determines a time window in which to implement the change based on availability of the network access node and a data model, which is built based on detected service events of wireless devices and functional dependencies with network access nodes. The time window has a period sufficient to complete the configuration change and is at a time that mitigates disruption to services for wireless devices served by the network access node. The change is orchestrated on the network access node during the time window. The orchestration is dynamically adjustable in real time based on a state of the network access node including the functional dependencies with network access nodes of the telecommunications network.

### BACKGROUND

Network change management is a process of planning, testing, and approving changes to network infrastructure. Network changes may be proactive efforts to improve the network or reactive responses to problems within the system. The goal of network change management is to minimize the risk of a failed change in the network, thereby reducing network disruptions, by following standardized procedures for controlled network changes. This process entails several steps that ensure successful changes. The network change management process relies on the application of several basic operating principles, including scope determination and risk analysis, peer review, pre-deployment testing and validation, implementation and testing, and documentation updates. Network teams perform the process of creating the change details-new configurations, device connection information, and documentation-prior to the change management process.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a call flow diagram of a process in which at least some aspects of the disclosed technology are implemented.

FIG. 4 is a flowchart of a method for implementing at least some aspects of the disclosed technology.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a system of a telecommunications network for coordinating the application of configuration changes to various network elements in the telecommunications network, resolving any interdependencies between the various changes, and applying the changes at an optimum moment to minimize the possibility of network outage caused by failed configuration changes. The system can be referred to as Dependency-aware Provisioning, Orchestration, and Service Execution (DePOSE). The system includes multiple functions having hardware and/or software to perform the dependency-aware provisioning, orchestration, and service execution. Examples of the functions include a DePOSE Manager function, a DePOSE Librarian function, and a DePOSE Agent function. In some implementations, the system can include more than one of any of the preceding DePOSE system functions.

The DePOSE Agent function is communicatively coupled with a trace processor function, which, in turn, is communicatively coupled with at least one service node of the telecommunications network. The service node is a network access node of a telecommunications network, which provides service to a user equipment (UE) of a subscriber of the telecommunications network. The service node is configured to communicate at least one periodic or aperiodic measurement report to the trace processor function. In some implementations, the measurement report communicated by the service node to the trace processor function can include information regarding at least one network measurement related to the UE, at least one network event related to the UE, at least one network configuration, or at least one network event related to the service node itself. In some implementations, the DePOSE Agent function receives the measurement report from the trace processor function and communicates the measurement report wholly or in part to the DePOSE Manager function. In some implementations, the DePOSE Agent function extracts information from the measurement report or determines a metric based on the measurement report and communicates the extracted information or the metric to the DePOSE Manager function.

The DePOSE Librarian function is configured to store at least one rule or at least one data model related to a configuration change to be implemented on the service node. The DePOSE Manager function is configured to analyze the network measurements, network events, network configuration, or metrics received from the DePOSE Agent function and the rules and data models stored at the DePOSE Librarian function to determine whether a proposed network configuration change is allowable and, if yes, determine the optimum window of time when it can be implemented so that the possibility of failure or service disruption to subscribers is minimized. In some implementations, the network configuration change is proposed by a human operator of the telecommunications network. In some implementations, the network configuration change is proposed by a network automation tool such as a self-optimizing network (SON).

The inventors have recognized a need for achieving high levels of consistency and accuracy in making critical network configuration changes to ensure a reliable user experience and network performance for subscribers of the telecommunications network. At any given time, multiple network engineering teams can perform manual network configuration changes and network optimization activities as part of limited trials. If the trial is successful and produces desirable results, some of these configuration changes may later be implemented across large parts of the telecommunications network. If the changes are network-impacting, e.g., require a network element to be restarted, or customer-impacting, e.g., cause subscribers to experience a loss or degradation of service while they are being implemented, they are implemented during a maintenance window at night. If the changes are not network- or customer-impacting, they can be implemented during the daytime. However, a large volume of configuration changes being applied simultaneously to a given network element may still overload the network element and cause service disruption, even if each of the applied changes individually is not network- or service-impacting.

Network automation and optimization tools such as SON may be configured to apply certain configuration changes in a large volume in real time as determined by their own internal algorithms. While the automatic configuration propagation is usually successful, some changes may not be correctly applied due to conflicts with other changes or failed retries due to network or other issues. Through deeply technical research, investigations, and troubleshooting, the inventors have identified the need to intelligently orchestrate the application of network configuration changes by taking into account the timing of planned and unplanned network outages, network freeze periods, and maintenance windows and by resolving functional interdependencies and conflicts between the various proposed configuration changes.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

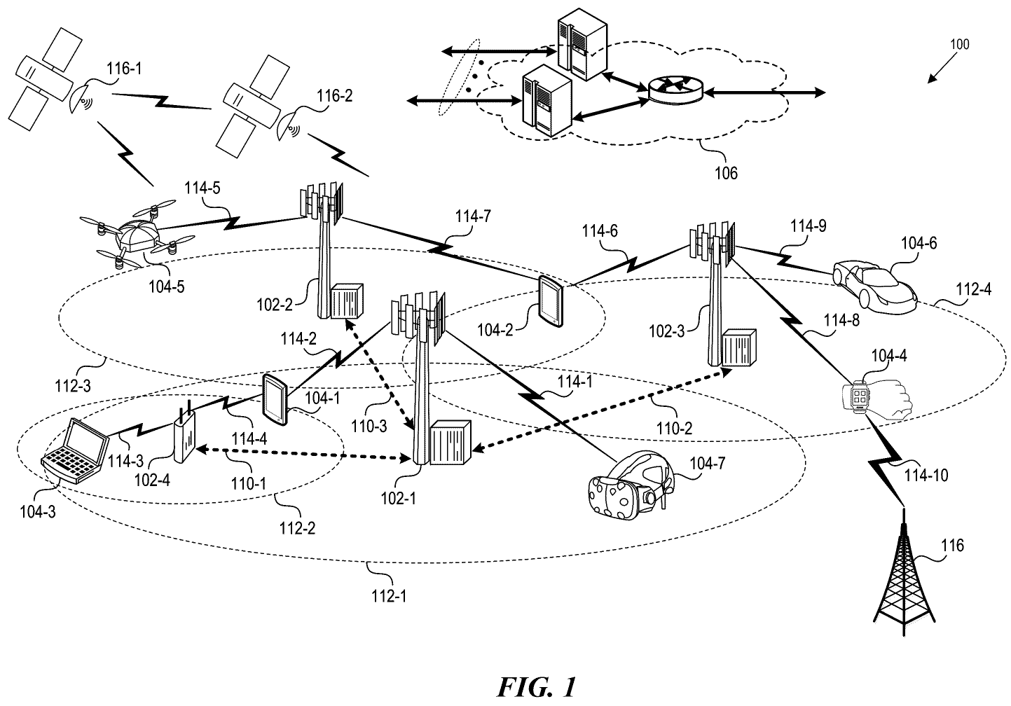

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

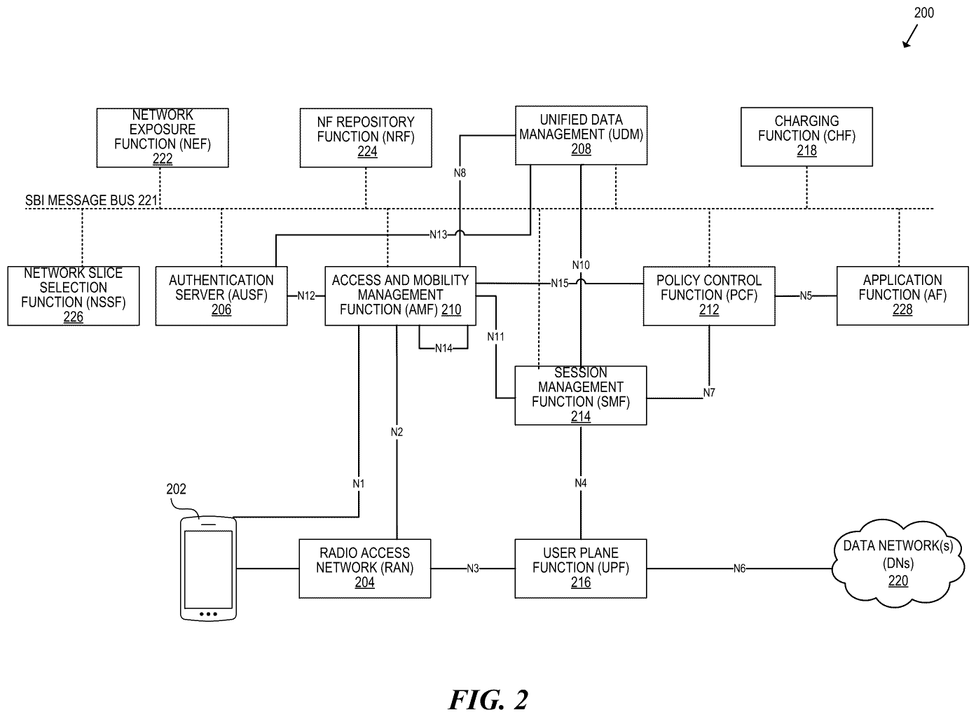

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### System for Dependency-aware Provisioning, Orchestration, and Service Execution

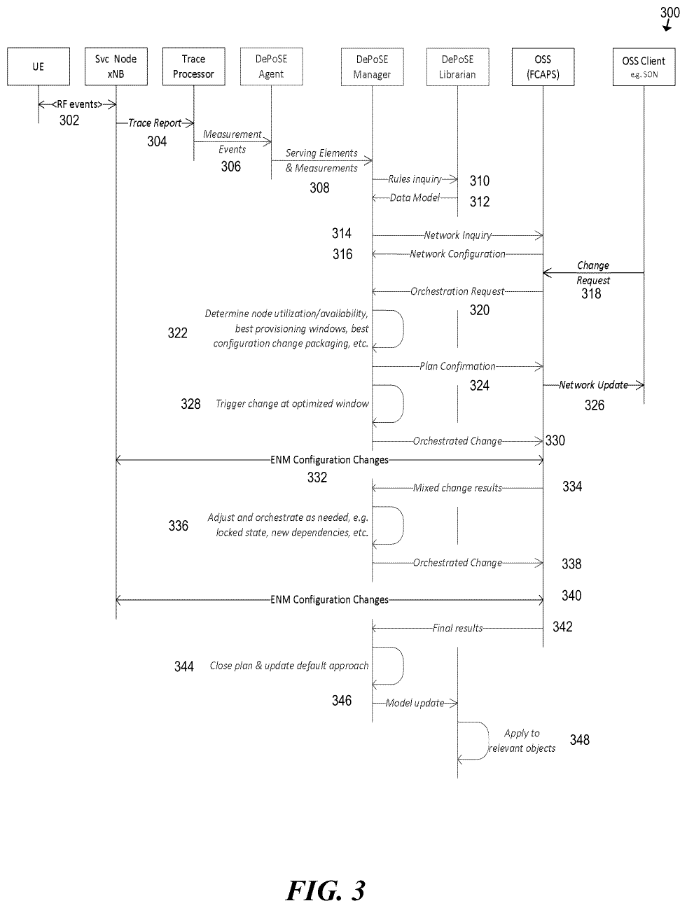

FIG. 3 is a call flow diagram of a system 300 of a telecommunications network in which at least some aspects of the disclosed technology are implemented. A user equipment (UE) is served by a service node, which can be an eNodeB if the telecommunications network is an LTE network, a gNodeB if the telecommunications network is a 5G network, or another type of network access node. The telecommunications network includes a trace processor function that comprises one or more network probes disposed at one or more locations within the coverage area of the telecommunications network, along with the necessary infrastructure to receive, store, and analyze network measurement, performance, and health reports received from one or more network probes and service nodes in the telecommunications network. The trace processor is communicatively coupled with at least one service node of the telecommunications network.

The telecommunications network includes a DePOSE Agent function that is communicatively coupled with a trace processor function, which, in turn, is communicatively coupled with at least one service node. The DePOSE Agent function is communicatively coupled with a DePOSE Manager function. The DePOSE Manager function is communicatively coupled with a DePOSE Librarian function and an Operation Support System (OSS) of the telecommunications network. The DePOSE Librarian function is configured to store at least one rule or at least one data model related to a configuration change to be implemented on the service node. The DePOSE Manager function is configured to analyze the network measurements, network events, network configuration, or metrics received from the DePOSE Agent function and the rules and data models stored at the DePOSE Librarian function to determine whether a proposed network configuration change is allowable. If allowable, the optimum window is determined as a time when the change can be implemented so that the possibility of failure (e.g., network performance degradation) is minimized.

The OSS manages service nodes of the telecommunications network and supports various network management functions such as fault management, configuration management, accounting management, performance management, and security management, collectively known as FCAPS functions. In some implementations, the OSS can be communicatively coupled with a client tool of the OSS. In some implementations, the client tool can be a network automation and optimization tool such as SON. The SON can be centralized (cSON) or decentralized (dSON).

At 302, under normal operation between the service node serving the UE, various radio frequency (RF) events can occur, including network registration and deregistration by the UE, service requests by the UE, handover events, location updates sent by the UE to the telecommunications network, and exchange of traffic between the UE and the service node. Under abnormal operation between the Service Node and the UE, the UE can experience loss or weakening of signal, dropped and/or blocked connections, reduction in data throughput, or increased latency and/or jitter.

At 304, the service node is configured to periodically or aperiodically send at least one trace report comprising UE performance and health metrics or service node performance and health metrics to the trace processor. The trace report can comprise information related to received signal strength reported by UE, received signal quality reported by UE, network latency, network jitter, traffic volume (tonnage), network reliability, network availability, peak data throughput, user data throughput, spectral efficiency, connection density, energy efficiency, mobility, configured spectral bandwidth, list of available service nodes as reported by the UE, and device model and software version of the UE.

At 306, the information contained in the trace reports is sent to the DePOSE Agent function. At 308, the DePOSE Agent function communicates information related to serving elements and measurements received from the trace processor to the DePOSE Manager function. In some implementations, the DePOSE Agent function receives the measurement report from the trace processor and communicates the measurement report wholly or in part to the DePOSE Manager function. In some implementations, the DePOSE Agent function extracts information from the measurement report or determines a network metric or a network event based on the measurement report and communicates the extracted information or the metric to the DePOSE Manager function.

At 310, the DePOSE Manager function sends a rules inquiry to the DePOSE Librarian function. In some implementations, the rules inquiry can pertain to a subset of service nodes in the telecommunications network. In some implementations, the rules inquiry can pertain to all service nodes in the telecommunications network.

At 312, the DePOSE Librarian function responds to the DePOSE Manager function with a rule or a data model pertaining to the service node for which the rules inquiry was sent. In some implementations, the rule or data model can include a provisioning rule related to preparing and equipping the service node to allow it to provide a service to subscribers of the telecommunications network. In some implementations, the rule or data model can include information regarding which configuration settings are allowed, disallowed, limited, required, or otherwise functionally interdependent with another configuration setting, hardware configuration, software version, or mode of operation of the service node. In some implementations, the DePOSE Librarian function's response can include the aforesaid information related to a subset of service nodes in the telecommunications network. In some implementations, the DePOSE Librarian function's response can include the aforesaid information related to all service nodes in the telecommunications network.

At 314, the DePOSE Manager function sends a network inquiry to the OSS. At 316, the DePOSE Manager function receives network configuration information from the OSS. The network configuration information can include, for example, information pertaining to network performance and health of the service node, information pertaining to the hardware type of the service node, and information pertaining to network outages affecting the local area of the service node.

At 318, the OSS receives a change request to implement at least one configuration change on at least one service node in the telecommunications network. In some implementations, the change request can be initiated by a human operator of the OSS. In some implementations, the change request can be initiated by a network automation and optimization tool such as SON.

At 320, in response to receiving the change request, the OSS sends an orchestration request to the DePOSE Manager function to determine whether the requested configuration change conflicts with any other planned or ongoing changes, whether the requested configuration change has any dependencies known to the DePOSE Manager function, whether the change cannot be implemented at a particular time without violating a network maintenance window or a network freeze period, and to determine the optimum window for implementing the change to minimize the possibility of failure in applying the change. A functional dependency can exist, for example, when a configuration setting cannot take a particular value without conflicting with another configuration or technical objective or when it cannot be configured independently of another configuration setting. The operator of the telecommunications network may have defined a network maintenance window, for example, to limit implementing certain network-impacting or customer-impacting changes on network elements, including service nodes, in the network to late night hours when network usage is likely to be low. The operator of the telecommunications network may have defined a network freeze period, for example, to avoid implementing certain network-impacting or customer-impacting changes on network elements, including service nodes, in the network on certain busy days of the year when network usage is likely to be high, such as on public holidays, New Year's Eve, etc.

At 322, the DePOSE Manager function analyzes information received from the DePOSE Agent function, DePOSE Librarian function, and OSS to determine whether the requested configuration change conflicts with another change request or an existing configuration, whether it meets a threshold probability of success when applied at a particular time, and how and in what order should the change be applied in relation with other changes requested.

At 324, the DePOSE Manager function sends a plan confirmation to the OSS, informing the OSS how and when the change will be applied. At 326, the OSS sends the information received from the DePOSE Manager function to the OSS client about the plan. If the DePOSE Manager function determines, based on its aforementioned analysis, that the optimum window of time in which to apply the requested change is in the future, the DePOSE Manager function keeps the implementation on hold until the start of the optimum window.

At 328, during the optimum window, the DePOSE Manager function initiates application of the change by communicating, at 330, an orchestrated change request to the OSS. At 332, the OSS implements the requested change by communicating the configuration change to the service node.

At 334, if the change is unsuccessful or partially successful, the OSS notifies the DePOSE Manager function accordingly. At 336, in response to learning about the full or partial failure of the change, the DePOSE Manager function reassesses the plan to determine a new window in which to apply the change or a different order in which to apply the change.

At 338, the DePOSE Manager function communicates a new orchestrated change request to the OSS. At 340, the OSS implements the new requested change by communicating the configuration change to the service node. In some implementations, steps 334-340 are repeated until the change is implemented successfully. In some implementations, steps 334-340 are repeated a limited number of times as per a configuration entered into the DePOSE Manager function by the operator of the telecommunications network.

At 342, the OSS communicates a final status regarding the success or failure of the change request to the DePOSE Manager function. At 344, the DePOSE Manager function closes the plan for implementing the change and updates the data model communicated to it by the DePOSE Librarian function in step 312.

At 346, the DePOSE Manager function communicates the updated data model to the DePOSE Librarian function. At 348, the DePOSE Librarian function updates an internal record it holds about the service node with the updated data model.

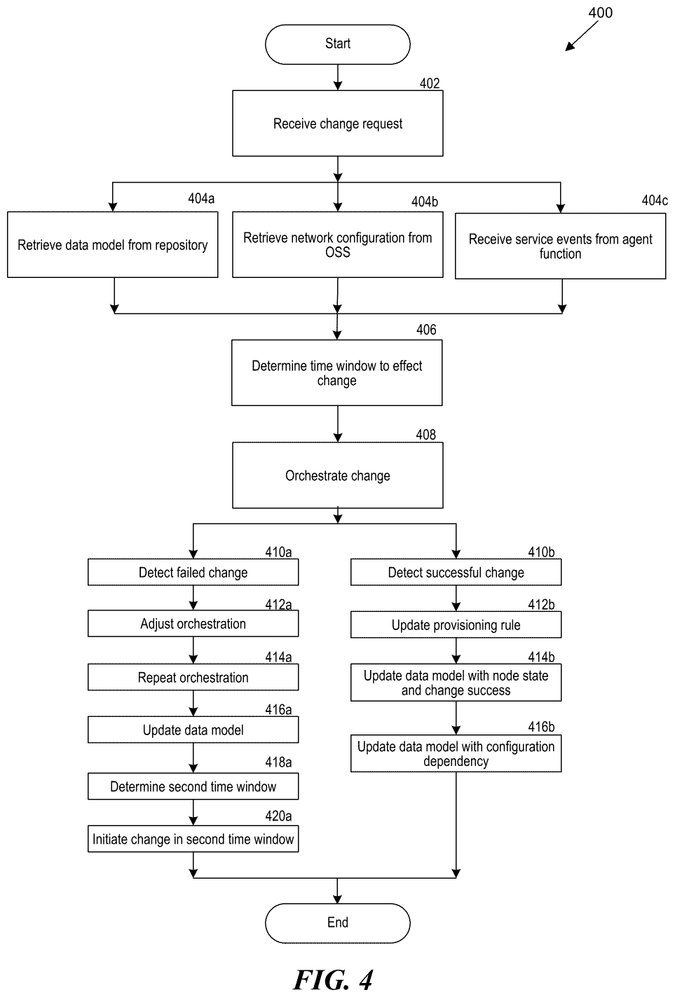

FIG. 4 is a flowchart of a method 400 for implementing at least some aspects of the disclosed technology. The disclosed technology relates to a system coupled to a telecommunications network comprising at least one hardware processor and at least one non-transitory memory storing instructions thereon. At 402, the instructions, when executed by the at least one hardware processor, cause the system to receive, from an Operation Support System (OSS), a request to change a configuration of a network access node of the telecommunications network. At 406, in response to the request to change the configuration of the network access node, the system determines a time window in which to effect the change in the configuration of the network access node based on availability of the network access node and a data model for the network access node. The data model for the network access node is built based on detected service events of wireless devices served by the network access node and functional dependencies with network access nodes of the telecommunications network. The time window has a period sufficient to complete the change in the configuration of the network access node and is at a time that mitigates disruption to services for wireless devices served by the network access node.

At 408, the system orchestrates the change in the configuration of the network access node during the time window. The orchestration is dynamically adjustable in real time based on a state of the network access node including the functional dependencies with network access nodes of the telecommunications network. At 404a, the system, prior to orchestrating the change in the configuration of the network access node, retrieves the data model of the network access node from a repository of the system. The data model is selected at the repository from among multiple data models for respective network access nodes of the telecommunications network. At 404b, the system retrieves a network configuration of the telecommunications network from the OSS. The time window is determined based on the network configuration of the telecommunications network in addition to the data model. At 404c, the system, prior to orchestrating the change in the configuration of the network access node, receives data indicative of service events collected by an agent of a manager function via a trace processor coupled to the network access node. The manager function is configured to determine the time window for the change in the configuration of the network access node. The service events include network registrations, service requests, handovers, location updates of wireless devices, or exchanges of network traffic between wireless devices and the network access node.

At 410a, the system detects a failure to complete the change in the configuration of the network access node. At 412a, in response to the failure to complete the change in the configuration of the network access node, the system adjusts orchestration of the change in the configuration of the network access node based on the dependencies with network access nodes of the telecommunications network. At 414a, the system repeats the orchestration until the change in the configuration of the network access node is completed or until a threshold number of attempts to change the configuration are performed. At 416a, the system, in response to failure in the change in the configuration of the network access node, updates the data model to indicate that the state of the network access node fails to enable the change in the network access node. At 418a, in response to failure in the change in the configuration of the network access node, the system treats the time window as a first time window and determines a second time window in which to implement the change in the configuration of the network access node. At 420a, the system initiates the change in the configuration of the network access node during the second time window.

At 410b, the system detects successful completion of the change in the configuration of the network access node. At 412b, in response to the successful completion of the change in the configuration of the network access node, the system updates a provisioning rule of the data model to include parameters to prepare and equip the network access node to serve subscribers of the telecommunications network. At 414b, in response to successful completion of the change in the configuration of the network access node, the system updates the data model to indicate that the state of the network access node enables change in the network access node.

At 416b, the system updates the data model including parameters indicative of a first configuration setting that is allowed, disallowed, limited, required, or interdependent on a second configuration setting, a hardware configuration, a software version, or a mode of operation of the service node.

### Computer System

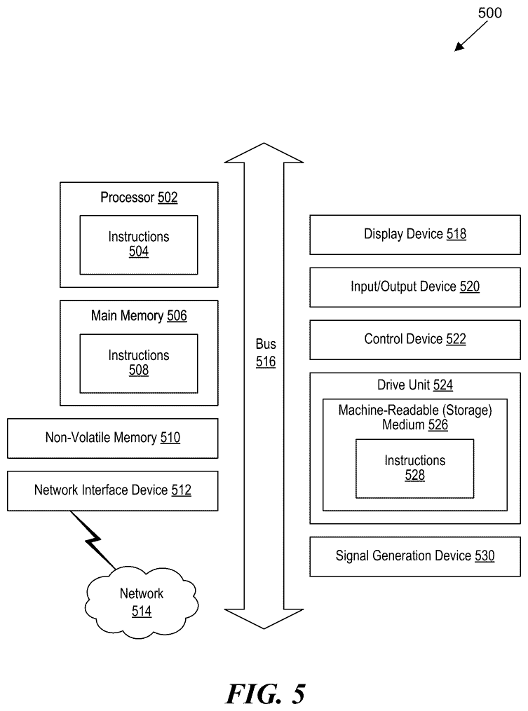

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A system coupled to a telecommunications network comprising:
at least one hardware processor; and
at least one non-transitory memory storing instructions, which, when executed by the at least one hardware processor, cause the system to:
receive, from an Operation Support System (OSS), a request to change a configuration of a network access node of the telecommunications network;
in response to the request to change the configuration of the network access node, determine a time window in which to effect the change in the configuration of the network access node based on availability of the network access node and a data model for the network access node,
wherein the data model for the network access node is built based on detected service events of wireless devices served by the network access node and functional dependencies with network access nodes of the telecommunications network, and
wherein the time window has a period sufficient to complete the change in the configuration of the network access node and is at a time that mitigates disruption to services for wireless devices served by the network access node; and
orchestrate the change in the configuration of the network access node during the time window,
wherein the orchestration is dynamically adjustable in real time based on a state of the network access node including the functional dependencies with network access nodes of the telecommunications network.

2. The system of claim 1 further caused to, prior to orchestrating the change in the configuration of the network access node:
retrieve the data model of the network access node from a repository of the system,
wherein the data model is selected at the repository from among multiple data models for respective network access nodes of the telecommunications network; and
retrieve a network configuration of the telecommunications network from the OSS,
wherein the time window is determined based on the network configuration of the telecommunications network in addition to the data model.

3. The system of claim 1 further caused to, prior to orchestrating the change in the configuration of the network access node:
receive data indicative of service events collected by an agent of a manager function via a trace processor coupled to the network access node,
wherein the manager function is configured to determine the time window for the change in the configuration of the network access node, and
wherein the service events include network registrations, service requests, handovers, location updates of wireless devices, or exchanges of network traffic between wireless devices and the network access node.

4. The system of claim 1 further caused to:
detect a failure to complete the change in the configuration of the network access node; and
in response to the failure to complete the change in the configuration of the network access node:
adjust orchestration of the change in the configuration of the network access node based on the functional dependencies with network access nodes of the telecommunications network, and
repeat the orchestration until the change in the configuration of the network access node is completed or until a threshold number of attempts to change the configuration are performed.

5. The system of claim 1 further caused to:
detect successful completion of the change in the configuration of the network access node; and
in response to the successful completion of the change in the configuration of the network access node, update a provisioning rule of the data model to include parameters to prepare and equip the network access node to serve subscribers of the telecommunications network.

6. The system of claim 1 further caused to:
update the data model including parameters indicative of a first configuration setting that is allowed, disallowed, limited, required, or interdependent on a second configuration setting, a hardware configuration, a software version, or a mode of operation of the network access node.

7. The system of claim 1 further caused to, in response to successful completion of the change in the configuration of the network access node:
update the data model to indicate that the state of the network access node enables change in the network access node.

8. The system of claim 1 further caused to, in response to failure in the change in the configuration of the network access node:
update the data model to indicate that the state of the network access node fails to enable the change in the network access node.

9. The system of claim 1, wherein the time window is a first time window, the system being further caused to, in response to failure in the change in the configuration of the network access node:
determine a second time window in which to implement the change in the configuration of the network access node.

10. The system of claim 9 further caused to:
initiate the change in the configuration of the network access node during the second time window.

11. A method for orchestrating a configuration change on a network access node of a telecommunications network, the method comprising:
receiving, from an Operation Support System (OSS), a request to change a configuration of a network access node of the telecommunications network;
in response to the request to change the configuration of the network access node, determining a time window in which to effect the change in the configuration of the network access node based on availability of the network access node and a data model for the network access node,
wherein the data model for the network access node is built based on detected service events of wireless devices served by the network access node and functional dependencies with network access nodes of the telecommunications network, and
wherein the time window has a period sufficient to complete the change in the configuration of the network access node and is at a time that mitigates disruption to services for wireless devices served by the network access node; and
orchestrating the change in the configuration of the network access node during the time window,
wherein the orchestration is dynamically adjustable in real time based on a state of the network access node including the functional dependencies with network access nodes of the telecommunications network.

12. The method of claim 11 further comprising, prior to orchestrating the change in the configuration of the network access node:
retrieving the data model of the network access node from a repository of the telecommunications network,
wherein the data model is selected at the repository from among multiple data models for respective network access nodes of the telecommunications network; and
retrieving a network configuration of the telecommunications network from the OSS,
wherein the time window is determined based on the network configuration of the telecommunications network in addition to the data model.

13. The method of claim 11 further comprising, prior to orchestrating the change in the configuration of the network access node:
receiving data indicative of service events collected by an agent of a manager function via a trace processor coupled to the network access node,
wherein the manager function is configured to determine the time window for the change in the configuration of the network access node, and
wherein the service events include network registrations, service requests, handovers, location updates of wireless devices, or exchanges of network traffic between wireless devices and the network access node.

14. The method of claim 11 further comprising:
detecting a failure to complete the change in the configuration of the network access node; and
in response to the failure to complete the change in the configuration of the network access node:
adjusting orchestration of the change in the configuration of the network access node based on the functional dependencies with network access nodes of the telecommunications network, and
repeating the orchestration until the change in the configuration of the network access node is completed or until a threshold number of attempts to change the configuration are performed.

15. The method of claim 11 further comprising:
detecting successful completion of the change in the configuration of the network access node; and
in response to the successful completion of the change in the configuration of the network access node, updating a provisioning rule of the data model to include parameters to prepare and equip the network access node to serve subscribers of the telecommunications network.

16. The method of claim 11 further comprising:
updating the data model including parameters indicative of a first configuration setting that is allowed, disallowed, limited, required, or interdependent on a second configuration setting, a hardware configuration, a software version, or a mode of operation of the network access node.

17. The method of claim 11 further comprising, in response to successful completion of the change in the configuration of the network access node:
updating the data model to indicate that the state of the network access node enables change in the network access node.

18. The method of claim 11 further comprising, in response to failure in the change in the configuration of the network access node:
updating the data model to indicate that the state of the network access node fails to enable the change in the network access node.

19. A non-transitory, computer-readable storage medium comprising instructions recorded thereon, wherein the instructions, when executed by at least one data processor of a system of a telecommunications network, cause the system to:
receive, from an Operation Support System (OSS), a request to change a configuration of a network access node of the telecommunications network;
in response to the request to change the configuration of the network access node, determine a time window in which to effect the change in the configuration of the network access node based on availability of the network access node and a data model for the network access node,
wherein the data model for the network access node is built based on detected service events of wireless devices served by the network access node and functional dependencies with network access nodes of the telecommunications network, and
wherein the time window has a period sufficient to complete the change in the configuration of the network access node and is at a time that mitigates disruption to services for wireless devices served by the network access node; and
orchestrate the change in the configuration of the network access node during the time window,
wherein the orchestration is dynamically adjustable in real time based on a state of the network access node including the functional dependencies with network access nodes of the telecommunications network.

20. The non-transitory, computer-readable storage medium of claim 19, wherein the system is further caused to, prior to orchestrating the change in the configuration of the network access node:
retrieve the data model of the network access node from a repository of the system,
wherein the data model is selected at the repository from among multiple data models for respective network access nodes of the telecommunications network; and
retrieve a network configuration of the telecommunications network from the OSS,
wherein the time window is determined based on the network configuration of the telecommunications network in addition to the data model.
